(19) United States
(12) Patent Application Publication
(10) Pub. No.: US 2024/0204325 A1
(43) Pub. Date: Jun. 20, 2024

(54) BATTERY TRAY SYSTEM, TRACTION BATERY, AND MOTOR VEHICLE

(71) Applicant: KAUTEX TEXTRON GmbH & Co. KG, Bonn (DE)

(72) Inventors: Weiwei Zhao, Bonn (DE); Hartmut Wolf, Konigswinter (DE)

(21) Appl. No.: 18/565,711

(22) PCT Filed: May 4, 2022
(86) PCT No.: PCT/EP2022/061951

§ 371 Date: Nov. 30, 2023

(30) Foreign Application Priority Data
May 31, 2021 (DE) 10 2021 113 995.3

(51) Int. Cl. H01M 50/242; H01M 50/227; H01M 50/249

(52) U.S. Cl. CPC H01M 50/242; H01M 50/227; H01M 50/249; H01M 2220/20

(57) ABSTRACT

A battery shell system of a traction battery. The battery shell system including a battery shell having a base, at least four side walls, an inner side, and an outer side. The battery shell has a maximum longitudinal extent in a longitudinal direction, a maximum transverse extent in a transverse direction, and a maximum vertical extent in a vertical direction. The battery shell has on the inner side a receiving space for receiving at least one battery module. The battery shell has at least one deformation element which can be connected to the outer side of the battery shell, which deformation element is formed separately from the battery shell. The deformation element has a deformation element transverse extent in the transverse direction of the battery shell, and the at least one deformation element is formed from plastic.

The present invention relates to a battery shell system, to a traction battery and to a motor vehicle.

In particular, the invention relates to a battery shell system having a battery shell and a deformation element having the battery shell.

In certain side collisions, a motor vehicle is thrown laterally into rigid objects such as trees or poles, whereby a side pole impact represents a substantial challenge for battery housings. In the side pole impact, a battery housing strikes a pole at high speed and thus with high energy. In order to protect the battery modules in the interior of the battery housing, the battery housing has to absorb the kinetic energy and provide the necessary deformation space.

The object of the invention is that of providing an improvement over or an alternative to the prior art.

According to a first aspect of the invention, the object is achieved by a battery shell system, in particular a battery shell system of a traction battery, wherein the battery shell system has the following features:
the battery shell system has a battery shell,
wherein the battery shell has a base and at least four side walls, wherein the battery shell has an inner side and an outer side, wherein the battery shell has a maximum longitudinal extent in a longitudinal direction, a maximum transverse extent in a transverse direction, and a maximum vertical extent in a vertical direction,
wherein the battery shell has on the inner side a receiving space for receiving at least one battery module,
wherein the battery shell system has at least one deformation element which can be connected to the outer side of the battery shell and is formed separately from the battery shell, wherein the deformation element has a deformation element transverse extent which extends in a designated manner in the transverse direction of the battery shell, and
wherein the at least one deformation element is formed from plastic.

In this regard, the following is explained conceptually:

It should first be expressly noted that in the context of the present patent application, indefinite articles and numbers such as “one,” “two,” etc. should generally be understood as “at least” statements, i.e. as “at least one . . . ,” “at least two . . . ,” etc., unless it is clear from the relevant context or it is obvious or technically imperative to a person skilled in the art that only “exactly one . . . ,” “exactly two . . . ,” etc. can be meant.

In the context of the present patent application, the expression “in particular” should always be understood as introducing an optional, preferred feature. The expression should not be understood to mean “specifically” or “namely.”

A “battery shell system” denotes a system consisting of a battery shell and at least one deformation element. In this case, the deformation element can be connected to the battery shell by means of a friction-locking and/or positive-locking connection means. Furthermore, it should be borne in mind that a deformation element of a battery shell system can be replaced.

A battery shell system preferably has two deformation elements, in particular a first deformation element on a first longitudinal side of the battery shell and a second deformation element on a second longitudinal side of the battery shell.

Alternatively, a battery shell system can also have two or three or more deformation elements on each longitudinal side of the battery shell.

A “traction battery” is understood to mean an energy storage device, in particular an energy storage device for electrical power. A traction battery is preferably suitable for installation in and for driving electric cars. A traction battery is preferably suitable for use in a battery-electric motor vehicle and/or a motor vehicle having a battery-electric drive and an internal combustion engine.

A “battery shell” is understood to mean a housing part of a battery, in particular of a traction battery.

In particular, a battery shell is configured for receiving components of a battery and accordingly has a “receiving space” for receiving components so that they can be protected by the battery shell from external influences and/or can be fastened at least indirectly within the battery shell.

The battery shell and the “battery cover” together form the essential components of the housing of a traction battery.

In particular, a battery shell has a “base” and, in the preferred case of a traction battery with a substantially rectangular outline, at least four “side walls”.

The base and side walls of the battery shell form the receiving volume of a battery shell, wherein the receiving volume of the battery shell describes the “inner side” of the battery shell.

Starting from the receiving volume of the battery shell, the “outer side” of the battery shell is located on the side of the base facing away from the receiving volume and the side walls.

A battery shell can have a square base area. In this case, a “transverse direction” of the battery shell is intended to mean a direction along a side wall of the battery shell.

If the battery shell has a base surface that is rectangular or otherwise deviates from a square shape, the longitudinal direction is understood to mean the direction of extension of the at least one side wall of the battery shell which has the longest extension.

In particular, the longitudinal extension direction is parallel to the base of the battery shell.

The “transverse direction” is understood to mean that direction which extends parallel to the base of the battery shell and at a right angle to the longitudinal direction of the battery shell. The transverse direction of the battery shell preferably corresponds substantially to the direction of a designated side pole impact. “Substantially” is understood here to mean differential angles less than or equal to 10°, preferably a differential angle less than or equal to 5° and particularly preferably a differential angle less than or equal to 2.5°.

A “vertical direction” is understood to mean that direction which runs in the direction of the normal to the plane spanned by the transverse direction and the longitudinal direction.

A “battery module” should be understood to mean at least a part of a battery module unit, wherein the battery module has a plurality of battery cells.

A “deformation element” is understood to mean an element which is formed separately from the battery shell, and which is configured to absorb the kinetic energy on the battery shell system in the event of a side impact, in particular in the event of a side pole impact, and to protect the battery shell from damage. As a result, the structural integrity of the battery shell can advantageously be maintained, at least with regard to the receiving space of the battery shell, so that a deformation or at least a critical deformation of a battery module can be prevented.

The deformation element in particular provides a deformation space, the deformation energy of which substantially corresponds to the energy of the side impact.

Particularly expediently, the deformation element is designed to be flexurally rigid compared to the side wall of the battery shell, whereby the kinetic energy of the side impact can advantageously be distributed over a larger side area of the battery shell.

A deformation element furthermore has a “deformation element transverse extent” which extends preferably in the transverse direction of the battery shell.

A deformation element “formed from plastic” is understood to mean a deformation element which is formed at least predominantly from plastic. Preferably, a deformation element is formed from plastic at more than or equal to 70% by volume, preferably at more than or equal to 80% by volume and particularly preferably at more than or equal to 90% by volume. Furthermore, a deformation element is preferably formed from plastic at more than or equal to 95% by volume, preferably at more than or equal to 97.5% by volume and particularly preferably at more than or equal to 99% by volume.

A battery shell system is proposed here which consists of a battery shell and at least one deformation element which can be connected directly or indirectly to the battery shell at a side wall and/or can be connected in a friction-locking and/or positive-locking manner. According to an expedient embodiment, the battery shell system has at least one deformation element at least on the two longitudinal sides of the battery shell, which deformation element is configured to absorb the kinetic energy from a side impact, in particular a side pole impact, and at least predominantly provides the deformation space necessary for this.

The battery shell system preferably has a plurality of deformation elements on the two longitudinal sides of the battery shell, in particular two, three or more deformation elements.

The deformation elements proposed here are made of plastic. As a result, in comparison to other materials, it is possible to achieve, on the one hand, a low weight for a deformation element and, on the other hand, as a result of the comparatively low modulus of elasticity and/or the comparatively high ductility, an advantageous deformation behavior, so that with a low additional weight the kinetic energy of a side impact can be transferred to a deformation of the deformation element, whereby a battery module in the interior of the battery shell can advantageously be protected from a critical deformation. In addition, a deformation element formed from plastic is comparatively inexpensive and can be produced with a comparatively complex geometry comparatively easily.

In the battery shell system proposed here, it is provided that a deformation element can be easily replaced, so that the repair costs resulting from a minor side impact are comparatively favorable.

According to a particularly preferred embodiment, the deformation element is formed from a ductile plastic, in particular from a plastic having an elongation at break greater than or equal to 0.3, preferably an elongation at break greater than or equal to 0.4, and particularly preferably an elongation at break greater than or equal to 0.5.

Furthermore, the deformation element is preferably formed from a plastic, wherein the plastic has an elongation at break greater than or equal to 0.55, preferably an elongation at break greater than or equal to 0.6, and particularly preferably an elongation at break greater than or equal to 0.65.

In this regard, the following is explained conceptually:
A “plastics material” is understood to mean a material that mainly consists of macromolecules.

A plastic is preferably a thermoplastic material, whereby a thermoplastic material is deformable in a material-dependent temperature range, this process being reversible and being repeatable as often as desired by cooling and reheating to the molten state.

“Elongation at break” refers to the elongation of a material sample in a single-axis tensile test in which a crack in the material sample occurs in comparison with the original length of the material sample in a stress-free state.

A deformation element formed from a ductile plastic advantageously makes it possible for the kinetic energy to be converted particularly advantageously into a deformation of the deformation element, in particular to be converted into the deformation element with a comparatively small penetration depth, whereby the crash performance of the battery shell system can advantageously be improved.

Particularly expediently, the deformation element is formed from a polymer blend.

In this regard, the following is explained conceptually:
A “polymer blend” is understood to mean a mixture of at least two different polymers.

By using a polymer blend, the material properties of the deformation element can be optimized compared to the use of a single polymer for the deformation element, in particular advantageously an improvement of the deformation behavior can be achieved so that the deformation energy is distributed over a larger region of the deformation element and the necessary deformation depth can thereby be reduced.

Optionally, the polymer blend has at least one of the plastic types polycarbonate and/or polybutylene terephthalate and/or polyphenylene ether and/or polystyrene and/or a polyamide, in particular a polyamide 6.6.

It has been found in laboratory tests that in particular polymer blends based on a combination of polycarbonate and polybutylene terephthalate or based on a combination of polyphenylene ether and polystyrene or based on a polyamide, in particular a polyamide 6.6, lead to particularly advantageous material behavior of the deformation element proposed here.

The deformation element is expediently formed using an injection-molding method or a compression molding method.

In this regard, the following is explained conceptually:
An “injection-molding method” is understood to mean a molding method, in which the plastic to be methoded is liquefied by means of an injection-molding machine and injected under pressure into a mold, i.e., the injection mold. In the injection mold, the material returns to its solid state as a result of cooling and/or a cross-linking reaction and can be removed as a component part after the injection mold has been opened.

A “compression molding method” is understood to mean a molding method in which the plastic is introduced into the cavity of an associated compression mold in a first step, wherein the compression mold closed in a second step, in particular with a pressure ram being used. By closure of the compression mold, the molding compound acquires the shape predetermined by the compression mold. The compression mold is preferably temperature-controlled.

Advantageously, it can thus be achieved that an established production method can be used for the battery shell proposed here, as a result of which costs can be saved and the process risk of the production process can be minimized.

The deformation element preferably has a honeycomb structure, in particular a honeycomb structure having a hexagonal cross-section, in particular a honeycomb structure having at least one honeycomb with a longitudinal axis, wherein the longitudinal axis of the at least one honeycomb corresponds substantially to the transverse direction of the battery shell in the designated installed state of the damping element.

In this regard, the following is explained conceptually:
A “honeycomb” is understood to mean a cell of a “honeycomb pattern” of two-dimensionally arranged hexagonal cavities comparable to a honeycomb cell. The hexagonal cavity is formed by six side faces, wherein adjacent side faces are arranged in particular at an angle of 120° to one another. A “longitudinal axis” here means a central axis of a honeycomb.

The term “substantially” means differential angles less than or equal to 10°, preferably a differential angle less than or equal to 5° and particularly preferably a differential angle less than or equal to 2.5°.

It can thereby preferably be achieved that the longitudinal axis of the at least one honeycomb in the designated installed state of the damping element corresponds substantially to the main deformation direction in the case of a designated side pole impact.

Honeycomb structures offer the advantage of a comparatively high flexural rigidity, in particular a comparatively high flexural stiffness about the longitudinal axis of a honeycomb.

In addition, honeycomb structures offer a comparatively efficient deformation behavior. Due to the geometric complexity of the deformations occurring during deformation, kinetic energy striking the deformation element can be converted particularly efficiently on a comparatively small deformation volume into deformation energy.

Overall, it can thus be achieved by means of a deformation element having a honeycomb structure that the penetration depth can be reduced in the event of a side pole impact, whereby a deformation element evaluated at the design point of a side pole impact according to the Euro-NCAP crash test can be designed to be particularly small, light and inexpensive.

Optionally, it should be borne in mind that the longitudinal axis of the at least one honeycomb in the designated installed state of the damping element substantially corresponds to the longitudinal direction of the battery shell.

Furthermore, it should optionally be borne in mind that the longitudinal axis of the at least one honeycomb in the designated installed state of the damping element corresponds substantially to the vertical direction of the battery shell.

As a result, a particularly good distribution of a kinetic energy acting in a punctiform manner on the deformation element can be achieved over the largest possible area at the opposite end of the deformation element.

According to a preferred embodiment, a honeycomb has a side length in a range of 8 mm to 16 mm, preferably a side length in a range of 10 mm to 14 mm, and particularly preferably a side length in a range of 11.5 mm to 12.5 mm. Particularly preferably, a honeycomb has a side length of exactly 12 mm.

In this regard, the following is explained conceptually:
The “side length” of a side face of a honeycomb is the length of a side face transverse to the longitudinal axis of a honeycomb and parallel to the side face. The side length is determined between the points of intersection with side faces adjacent on both sides, in particular between the points of intersection of the corresponding planes of symmetry.

In a series of numerical and experimental laboratory tests, it was found completely unexpectedly that a side length in the ranges specified above is particularly advantageous for the deformation behavior of the deformation element proposed here. It should be expressly noted here that the above values of the range limits can also be combined with one another in other combinations without departing from the aspect of the invention which is left here.

It should be expressly pointed out that the above values for the side length of a honeycomb should not be understood as strict limits; rather, it should be possible to exceed or fall below them on an engineering scale without departing from the described aspect of the invention. In simple terms, the values are intended to provide a guide for the size of the range proposed here of the side length of a honeycomb.

A honeycomb preferably has a wall thickness greater than or equal to 1.2 mm, preferably a wall thickness greater than or equal to 1.4 mm and particularly preferably a wall thickness greater than or equal to 1.6 mm. Furthermore, particularly preferably, a honeycomb has a wall thickness greater than or equal to 1.0 mm, preferably a wall thickness greater than or equal to 1.8 mm and particularly preferably a wall thickness greater than or equal to 2.0 mm.

In this regard, the following is explained conceptually:
The “wall thickness” is understood to mean the thickness of the wall of a honeycomb transversely to one side of the honeycomb. Preferably, a honeycomb has the same wall thickness at every location. Furthermore preferably, a wall thickness of a honeycomb along the faces of the honeycomb forming the sides deviates by not more than 5% from the mean wall thickness of the honeycomb. In this case, the wall thickness means the mean wall thickness of the honeycomb.

The wall thickness of a honeycomb is preferably less than or equal to 2.0 mm, preferably less than or equal to 1.8 mm and particularly preferably less than or equal to 1.6 mm.

In a series of numerical and experimental laboratory tests, it was found completely unexpectedly that a wall thickness according to the values specified above is particularly advantageous for the deformation behavior of the deformation element proposed here.

It should be expressly pointed out that the above values for the wall thickness of a honeycomb should not be understood as strict limits; rather, it should be possible to exceed or fall below them on an engineering scale without departing from the described aspect of the invention. In simple words, the values are intended to provide a guide for the size of the range proposed here of the wall thickness of a honeycomb.

According to a particularly expedient embodiment, a honeycomb has a ratio of wall thickness to side length, in particular at a side length of 12 mm, in a range of greater than or equal to 0.08 and less than or equal to 0.18, preferably in a range of greater than or equal to 0.095 and less than or equal to 0.16, and particularly preferably in a range of greater than or equal to 0.11 and less than or equal to 0.14.

In a series of numerical and experimental laboratory tests, it was found completely unexpectedly that the ratio of wall thickness to side length of a honeycomb in the ranges specified above is particularly advantageous for the deformation behavior of the deformation element proposed here. It should be expressly noted here that the above values of the range limits can also be combined with one another in other combinations without departing from the aspect of the invention which is left here.

It should be expressly noted that the above values for the ratio of wall thickness to side length of a honeycomb are not intended to be sharp limits, but rather are intended to be capable of being exceeded or undercut on an engineering scale without departing from the described aspect of the invention. In simple terms, the values are intended to provide a guide for the size of the range proposed here of the ratio of wall thickness to side length of a honeycomb.

A honeycomb preferably has a honeycomb longitudinal extent greater than or equal to 50 mm, preferably greater than or equal to 60 mm and particularly preferably greater than or equal to 70 mm. Furthermore, a honeycomb preferably has a honeycomb longitudinal extent greater than or equal to 80 mm, preferably greater than or equal to 90 mm and particularly preferably greater than or equal to 100 mm.

In this regard, the following is explained conceptually:
The “honeycomb longitudinal extent” is understood to mean the extent of a honeycomb along the longitudinal axis of a honeycomb.

In a series of numerical and experimental laboratory tests, it was found completely unexpectedly that a honeycomb longitudinal extent according to the values indicated above is particularly advantageous for the deformation behavior of the deformation element proposed here.

It should be expressly pointed out that the above values for the honeycomb longitudinal extent of a honeycomb should not be understood as strict limits; rather, it should be possible to exceed or fall below them on an engineering scale without departing from the described aspect of the invention. In simple terms, the values are intended to provide a guide for the size of the range proposed here of the honeycomb longitudinal extent of a honeycomb.

Expediently, the battery shell has an outer stiffening means, in particular an outer stiffening means which is formed monolithically with the battery shell, in particular an outer stiffening means arranged between the receiving space of the battery shell and the designated deformation element connected to the battery shell, wherein the outer stiffening means has a stiffening means transverse extent in the transverse direction of the battery shell.

In this regard, the following is explained conceptually:
An “outer stiffening means” is understood to mean a geometric configuration of the battery shell on the outer side of the battery shell and/or a material change of the battery shell which is configured to stiffen the battery shell.

An outer stiffening means is preferably configured to stiffen the base of the battery shell and/or at least one side wall of the battery shell.

Preferably, an outer stiffening means is intended to mean a profile of at least one side wall of the battery shell, wherein the profiling of the at least one profiled side wall of the battery shell increases at least one area moment of inertia of the at least one profiled side wall of the battery shell, particularly preferably two area moments of inertia of the at least one profiled side wall of the battery shell, relative to a side wall of a battery shell without profiling and with comparable wall thickness and comparable material composition.

A profiling is intended preferably to mean an I-profile, a U-profile, a T-profile, a Z-profile, an L-profile, a profile cumulatively composed from the previously mentioned profiles or a different profiling.

It should be expressly pointed out that a profiling can be understood to mean any geometric change relative to a planar extension of at least one side wall and/or the base of the battery shell.

Preferably, an outer stiffening means is intended to mean a profile of at least one side wall of the battery shell, wherein the profiling of the at least one profiled side wall of the battery shell increases at least one area moment of inertia of the at least one profiled side wall of the battery shell, particularly preferably two area moments of inertia of the at least one profiled side wall of the battery shell, relative to a side wall of a battery shell without profiling and with comparable wall thickness and comparable profiling.

In the case of a material change to achieve an outer stiffening means, it is intended in particular to add fiber material in at least one wall and/or the base of the battery shell, wherein the fiber material is arranged such that it can increase at least one area moment of inertia, preferably two area moments of inertia, of the at least one side wall and/or of the base of the battery shell.

It should be expressly pointed out that the aspect of an outer stiffening means presented here is not limited to a stiffening of one side wall of the battery shell, rather, even two or more side walls of the battery shell, preferably all of the side walls of the battery shell, can have an outer stiffening.

It should be expressly pointed out that a side wall can represent a component of an outer stiffening means.

An outer stiffening means which is formed “monolithically” with the battery shell is understood to mean an outer stiffening means which is produced in a coherent and seamless manner in a single component with the battery shell.

In other words, an outer stiffening means, which is formed jointly monolithically with the battery shell, is not composed of a plurality of individual parts nor of a plurality of individual parts joined by bonding, for example, by means of a welding method and/or joined to the rest of the battery shell. It is rather the case that an outer stiffening means which is formed together monolithically with the battery shell is seamless. It is understood that in this case the battery shell also is seamless.

Preferably, a monolithically formed battery shell is understood to mean an off-tool battery shell, i.e., a battery shell that is produced in one step with the aid of a tool.

It can thereby be advantageously achieved that the battery shell together with the outer stiffening means can be produced inexpensively in a single manufacturing step, wherein the transition from a stiffening means to a side wall and/or the base of the battery shell presents no additional risk of failure due to a weld seam or a deviating connection.

An inherent tightness of a battery shell can thus also advantageously be achieved.

A “stiffening means transverse extent” denotes the extent of an outer stiffening means in the transverse direction of the battery shell.

Among other things, it is proposed here that the battery shell has at least one outer stiffening means. In combination with the deformation element, a side wall of a battery shell together with the outer stiffening means is thus advantageously made possible, which side wall is designed to be rigid in comparison to the deformation element and provides a particularly rigid installation space protection for the receiving space for a battery module. The comparatively soft deformation element, which for this purpose is comparatively soft, can thus optimally provide the required deformation space and having the at least one outer stiffening means can be supported with respect to the installation space protection.

With the outer stiffening means proposed here, a designated distance between a battery module and the side wall of the battery shell, in particular the cover layer of the battery shell, can advantageously be minimized.

Optionally, the outer stiffening means has a U-profile that is open in the vertical direction of the battery shell.

In this regard, the following is explained conceptually:
A “U-profile” is understood to mean a cross-section of the outer stiffening means, in particular a cross-section formed from the cover layers of the outer stiffening means and the connection between the cover layers, the connection being away from the core. In other words, a U-profile means a rectangle which is hollow inside or has a core and which lacks a continuous side face, i.e., is open at least partially in the direction of a side face.

The U-profile is preferably open downwards or upwards with respect to the vertical direction of the battery shell.

The outer stiffening means preferably has a T-profile open in the vertical direction of the battery shell.

In this regard, the following is explained conceptually:
A “T-profile” is understood to mean a profile cross-section which, disregarding one or more core areas, is reminiscent of the shape of the letter T, wherein the cross-section consists of at least two side faces oriented perpendicular to one another with their axes of symmetry, and wherein one side face meets the other side face substantially in the middle of the latter.

A T-profile is preferably also understood to mean an I-profile whose cross-section consists of two T-profiles connected to one another in opposite directions, so that the cross-section of an I-profile is reminiscent of the shape of the letter I.

A T-profile and/or an I-profile can have one or more core areas with corresponding cores.

Among other things, an outer stiffening means is proposed here, which is open upwards and downwards at least partially in relation to the vertical direction of the battery shell.

With an external stiffening means having an I-profile, an external stiffening means can be achieved which, with a comparable stiffness, has a particularly short transverse extent, so that more installation space can be provided in the designated motor vehicle for a deformation element and/or for a battery module.

Particularly expediently, the outer stiffening means has a core, in particular a structured core, in particular a core in the middle of two cover layers bounding the core, in particular a structured core having a cross-rib structure.

In this regard, the following is explained conceptually:
A “core” can be described by the fact that it has a lower specific weight compared to the cover layers. Preferably, a core has a particularly high stability in relation to transverse contraction, in particular in relation to a transverse contraction caused by a bending of the stiffening means.

Preferably, a core has a geometry deviating from the cover layers, by means of which the specific properties of the core can advantageously be achieved.

Preferably, a core has a material composition deviating from the cover layers, by means of which the specific properties of the core can advantageously be achieved.

Preferably, the core has a porous material.

Preferably, the core consists of wood, in particular balsa wood.

The core preferably consists of aluminum, in particular of an aluminum honeycomb or an aluminum foam.

A “structured core” is understood to mean both a core with a geometry differing from the cover layers and/or a core with material characteristics differing from the cover layers, wherein a structured core has a structure.

A “cross-rib structure” is understood to mean a geometry of a core, wherein the core has ribs, the respective ends of which preferably form the nodal points of the rib structure.

Preferably, a cross-rib structure is configured to divert the compressive forces and/or shear forces that occur in a core into the bounding cover layers.

Preferably, a structured core, in particular a structured core having a cross-rib structure, is formed with a corresponding structural-core tool from the upper side of the battery shell and/or from the outer side of the battery shell.

Preferably, ribs are planar or substantially planar.

Preferably, ribs adjacent to each other share only one common nodal point.

Preferably, a cross-rib structure has a zigzag pattern.

Preferably, cross ribs, like the diagonals, intersect in a rectangle.

A “cover layer” is understood to mean a material layer which bounds a core of a stiffening means in sandwich construction.

Preferably, a cover layer has a material change relative to the material of the battery shell, preferably in the form of fiber material introduced into the cover layer, which is preferably configured to increase the stiffness of the cover layer in an extension direction of the cover layer.

In other words, an outer stiffening means is proposed here which has a sandwich construction, which is understood to mean a regionwise combination of different geometries and/or material properties, as a result of which the different regions have different material properties, which can advantageously be combined to form a particularly lightweight and rigid outer stiffening means.

In particular, a sandwich construction is understood to mean a planar construction or a substantially planar construction of a stiffening means, the sandwich construction comprising a core which is bordered by two outer layers directly adjacent to the core.

The outer stiffening means proposed here in sandwich construction advantageously enables a lightweight construction of an outer stiffening means. Thus, with the same stiffness, weight and material can be saved compared to an outer stiffening means without a sandwich construction. Alternatively, the stiffness of the outer stiffening means can be increased for the same weight.

A ratio of the deformation element transverse extent to the stiffening means transverse extent is preferably greater than or equal to 1, preferably greater than or equal to 1.3, and particularly preferably greater than or equal to 1.6.

In a series of numerical and experimental laboratory tests, it was found completely unexpectedly that ratio of the deformation element transverse extent to the stiffening means transverse extent according to the above values is particularly advantageous for the deformation behavior of the battery shell system proposed here.

It should be expressly noted that the above values for the ratio of deformation element transverse extent to the stiffening means transverse extent are not intended to be sharp limits, but rather are intended to be able to be exceeded or undercut on an engineering scale without departing from the aspect of the invention described. In simple terms, the values are intended to provide an indication of the size of the range proposed here of the ratio of the deformation element transverse extent to the stiffening means transverse extent.

Particularly preferably, a ratio of the deformation element transverse extent to the stiffening means transverse extent lies within a range greater than or equal to 1.2 and less than or equal to 1.45, in particular of 4/3, in particular in the case of an outer stiffening means having a U-profile.

Furthermore, a ratio of the deformation element transverse extent to the stiffening means transverse extent particularly preferably lies within a range greater than or equal to 2.3 and less than or equal to 2.7, in particular 2.5, in particular in the case of an outer stiffening means having a T-profile.

According to an expedient embodiment, a ratio of the deformation element transverse extent to the stiffening means transverse extent is greater than or equal to 1.2, preferably greater than or equal to 1.5, and particularly preferably greater than or equal to 1.8. Furthermore, a ratio of the deformation element transverse extent to the stiffening means transverse extent is expediently greater than or equal to 2.1, preferably greater than or equal to 2.4, and particularly preferably greater than or equal to 2.7.

Particularly expediently, the outer stiffening means has one or more, in particular two, continuous-fiber-reinforced reinforcement layers. As a result, an overall intrusion in the case of a side pole impact can advantageously be reduced. Furthermore, it was possible to show that in the case of the same designated total intrusion with an outer stiffening means having one or more, in particular two, continuous fiber-reinforced reinforcement layers, a core which is thinner with regard to its thickness in the transverse direction of the battery shell can be achieved, as a result of which the battery shell and in particular the outer stiffening means can be made lighter overall.

Particularly expediently, the battery shell has a holding structure for guiding and/or connecting the deformation element, in particular a holding structure which is monolithically formed with the battery shell, in particular a holding structure arranged on the outer side of the battery shell, in particular a holding structure arranged outside an outer stiffening device as viewed from the receiving space.

In this regard, the following is explained conceptually:
A “holding structure” is understood to mean a region of the structure of a battery shell which is designed specifically for positive-locking and/or friction-locking connection to one or more deformation elements.

A holding structure preferably extends on the outer side of the battery shell, preferably outside an outer stiffening means.

Preferably, a holding structure has a transverse extent which exceeds the length of its vertical extent.

A holding structure is preferably arranged substantially at half the height of the battery shell. Preferably, a holding structure has a T-profile, in the core areas of which a deformation element can at least partially be received.

Preferably, a holding structure is configured to be connected to a first deformation element on the upper side and a second deformation element on the underside.

The holding structure is expediently connected monolithically to the battery shell, wherein the holding structure can be directly connected to the outer stiffening means.

Among other things, a battery shell having a holding structure is proposed here, which is configured to form a friction-locking clamping connection with a deformation element. In this way, a deformation element can be installed and replaced particularly easily and inexpensively.

Furthermore, it should be borne in mind that the holding structure has a through-opening and deformation elements arranged on both sides of the holding structure are clamped against one another with a connecting means, so that the holding structure is clamped between the deformation elements between by the connecting means.

The holding structure preferably has a connection means which is configured to connect to the at least one deformation element.

In this regard, the following is explained conceptually:
A “connecting means” is understood to mean any means which is configured for connecting a deformation means to the battery shell. A connecting means is preferably a through-opening in the holding structure, which through-opening enables a friction-locking and/or positive-locking connection, in particular a screwed connection, between the battery shell and the at least one deformation element and/or the body shell of a designated motor vehicle.

Among other things, a holding structure is proposed here, which extends substantially parallel to the designated base of the designated motor vehicle, whereby a deformation element can be optimally aligned.

Furthermore, among other things, a holding structure in the form of an I profile is proposed, which at least partially encloses the at least one deformation element on at least two sides, in particular which at least partially encloses the at least one deformation element on three sides.

A wall thickness of the holding structure is preferably less than or equal to 4 mm, preferably less than or equal to 3 mm, and particularly preferably less than or equal to 2 mm.

In particular, adjacent to an outer stiffening means having a U-profile, it can be achieved with the comparatively small wall thickness of the holding structure proposed here that the holding structure collapses before the outer stiffening means. In this way, in the case of particularly high-energy side impact situations, the region of the expected deformation can be kept as far away as possible from a designated battery module.

Optionally, the battery shell has at least one inner stiffening means which, on the outer side of the battery shell, also extends over the deformation element transverse extent, in particular which extends on the outer side of the battery shell also over the deformation element transverse extent and the stiffening means transverse extent.

In this regard, the following is explained conceptually:
An “inner stiffening means” is understood to mean a geometric configuration of the battery shell on the inner side of the battery shell which is configured to stiffen the battery shell.

Preferably, an inner stiffening means is a rib. Arib is understood to mean a geometry exhibited in the interior of the battery shell and configured to stiffen the battery shell.

Preferably, a rib is a transverse rib, wherein a transverse rib extends in the transverse direction of the battery shell and is configured to increase at least one area moment of inertia, particularly preferably two area moments of inertia, of a cross-section of the battery shell running normal to the transverse direction, so that the battery shell is stiffened.

It is proposed here that an inner stiffening means of the battery shell extends not only in the receiving space of the battery shell but also over the extent of the holding structure or also over the extent of the outer stiffening means and the holding structure.

Furthermore, it is proposed that a connection means for connecting the battery shell and the deformation element and/or the body shell of a designated motor vehicle is arranged in the immediate vicinity of the inner stiffening means, so that loads introduced into the deformation element and thus into the connection means in the event of a side impact can be absorbed at a point of the battery shell structure that is as rigid as possible.

In addition, an extension of an inner stiffening means can additionally stiffen a designated horizontally extending region of the holding structure.

The battery shell is preferably formed from plastic.

In this regard, the following is explained conceptually:
A battery shell “formed from plastic” is understood to mean a battery shell which is formed at least predominantly from plastic. Preferably, a battery shell is formed from plastic at more or equal to 70% by volume, preferably at more than or equal to 80% by volume and particularly preferably at more or equal to 90% by volume. Further preferably, a battery shell is formed from plastic at more or equal to 95% by volume, preferably at more than or equal to 97.5% by volume and particularly preferably at more than or equal to 99% by volume.

The battery shell is preferably formed by means of an injection-molding method or a compression-molding method.

In particular, battery shells formed from plastic often have a plastic as their material, which plastic is reinforced by means of long-cut fibers in order thus to improve the rigidity of the battery shell. With regard to a side impact, however, such battery shells can only absorb a comparatively low kinetic energy before a critical deformation is reached, since the elongation at break of the material, in particular as a result of the influence of the long-cut fibers, is comparatively low. The long-cut fibers preferably have a length greater than or equal to 15 mm. Furthermore, the long-cut fibers preferably have a length greater than or equal to 20 mm, preferably a length greater than or equal to 25 mm and particularly preferably length greater than or equal to 30 mm.

In this respect, a combination of the deformation element proposed here and a battery shell formed from plastic to form a battery shell system proposed here is particularly advantageous.

Optionally, the at least one outer stiffening means and/or the holding structure has a fiber-reinforced reinforcement layer, in particular a continuous-fiber-reinforced reinforcement layer.

In this regard, the following is explained conceptually:
A “continuous-fiber-reinforced reinforcement layer” is understood to mean a layer having fibers, in particular glass fibers, carbon fibers, aramid fibers or the like, and a plastic matrix. The fibers are preferably arranged oriented relative to one another and/or have a length greater than or equal to 15 mm. Furthermore, the fibers preferably have a length greater than or equal to 20 mm, preferably a length greater than or equal to 25 mm and particularly preferably a length greater than or equal to 30 mm.

Advantageously, the stiffness of the battery shell can be increased by the continuous-fiber-reinforced reinforcement layer, in particular in the region of the continuous-fiber-reinforced reinforcement layer, and/or the weight of the battery shell can be reduced with comparable stiffness.

Among other things, it should be specifically borne in mind that the battery shell has a continuous-fiber-reinforced reinforcement layer in the region of the side wall. If a side impact occurs and a deformation reaches the side wall of the battery shell via the deformation element, it will thus be possible to prevent or at least reduce a penetration of the deformation by the side wall reinforced by means of the continuous-fiber-reinforced reinforcement layer onto the designated battery module in the receiving space of the battery shell.

According to a second aspect of the invention, the object is achieved by a traction battery, in particular a traction battery for a motor vehicle, comprising a battery shell according to the first aspect of the invention.

In this regard, the following is explained conceptually:
A “motor vehicle” is understood to mean a vehicle driven by a motor. A motor vehicle is preferably not mounted on a rail or at least not permanently track-mounted.

It should be understood that the advantages of a battery shell according to the first aspect of the invention, as described above, extend directly to a traction battery comprising a battery shell according to the first aspect of the invention.

According to a third aspect of the invention, the object is achieved by a motor vehicle comprising a battery shell according to the first aspect of the invention and/or a traction battery according to the second aspect of the invention.

It should be understood that the advantages of a battery shell according to the first aspect of the invention, as described above, and/or a traction battery according to the second aspect of the invention, extend directly to a motor vehicle comprising a battery shell according to the first aspect of the invention and/or a traction battery according to the second aspect of the invention.

Further advantages, details and features of the invention can be found below in the described embodiments. In the figures, in detail:

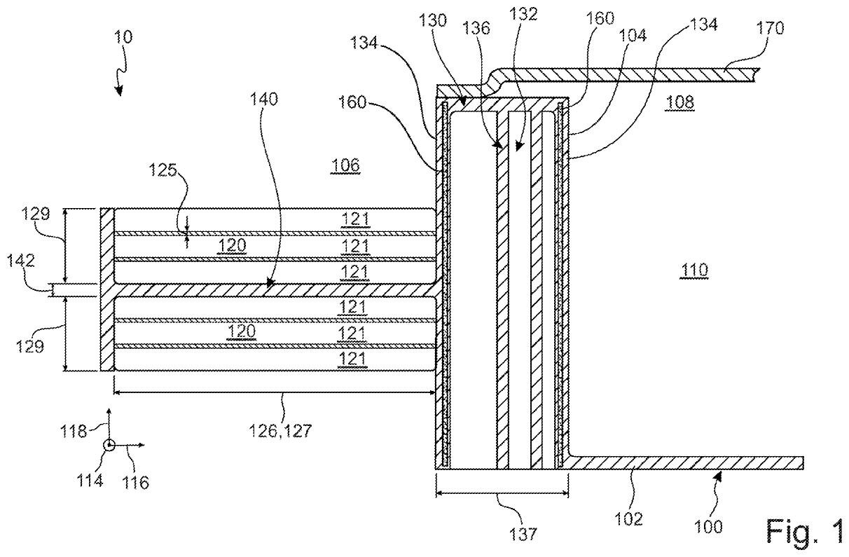

FIG. 1: schematically shows a detail of a first embodiment of a battery shell system in a sectional view;

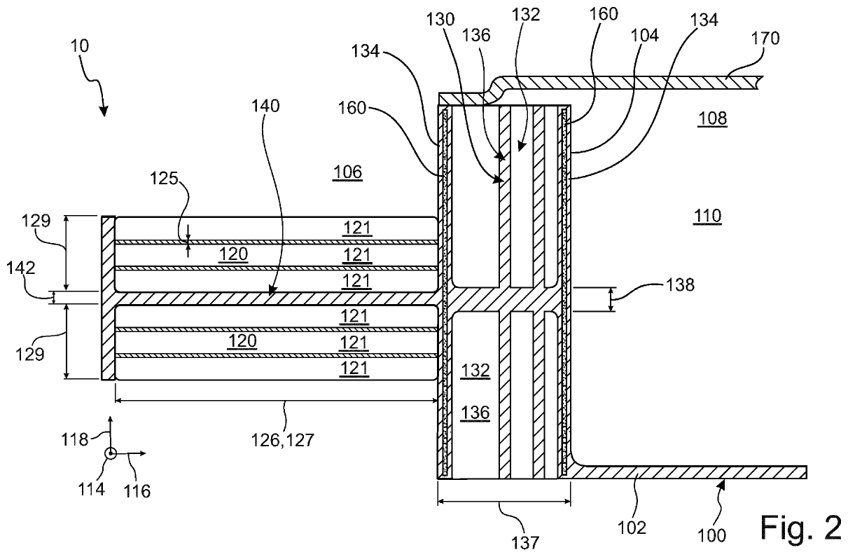

FIG. 2: schematically shows a detail of a second embodiment of a battery shell system in a sectional view;

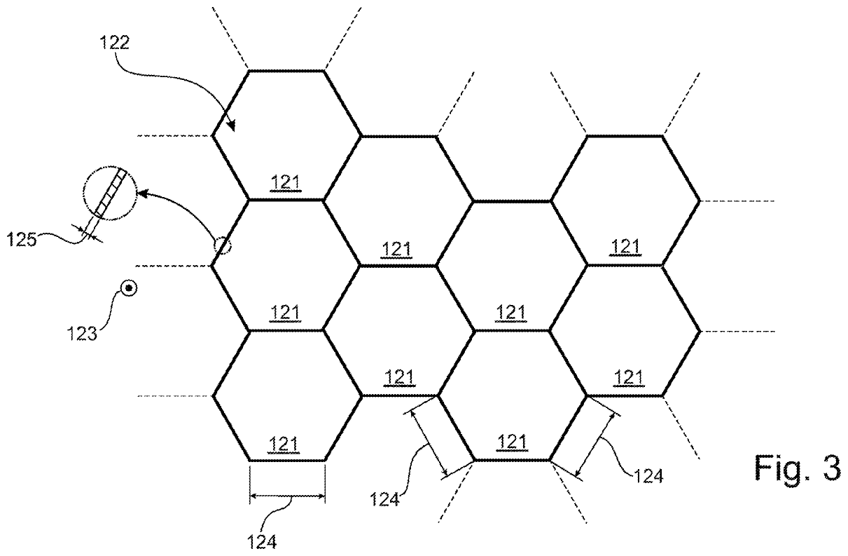

FIG. 3: schematically shows a honeycomb structure of a deformation element;

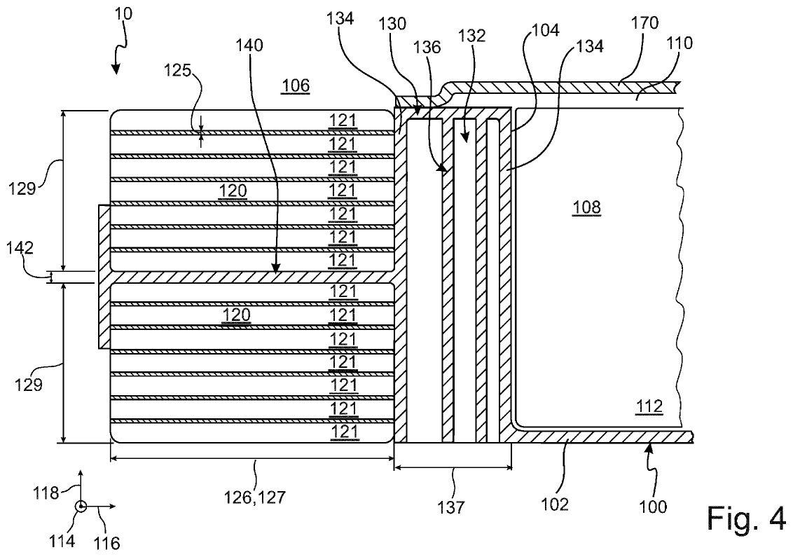

FIG. 4: schematically shows a detail of a third embodiment of a battery shell system in a sectional view;

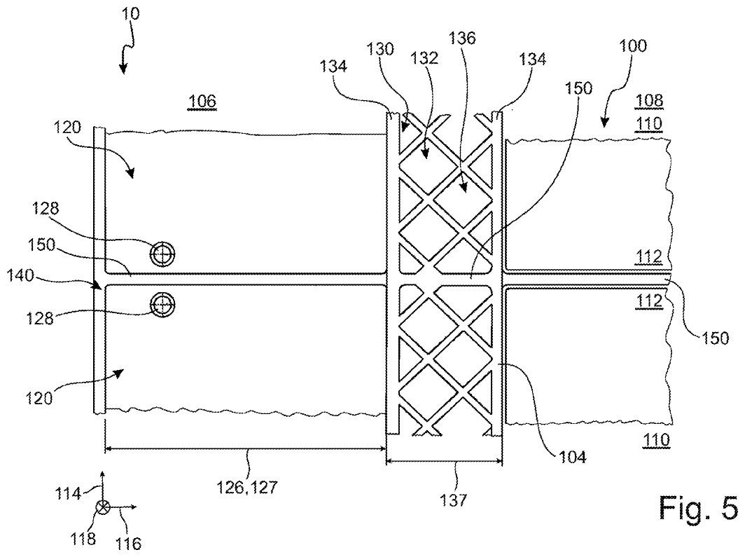

FIG. 5: schematically shows a detail of a fourth embodiment of a battery shell system in a plan view; and

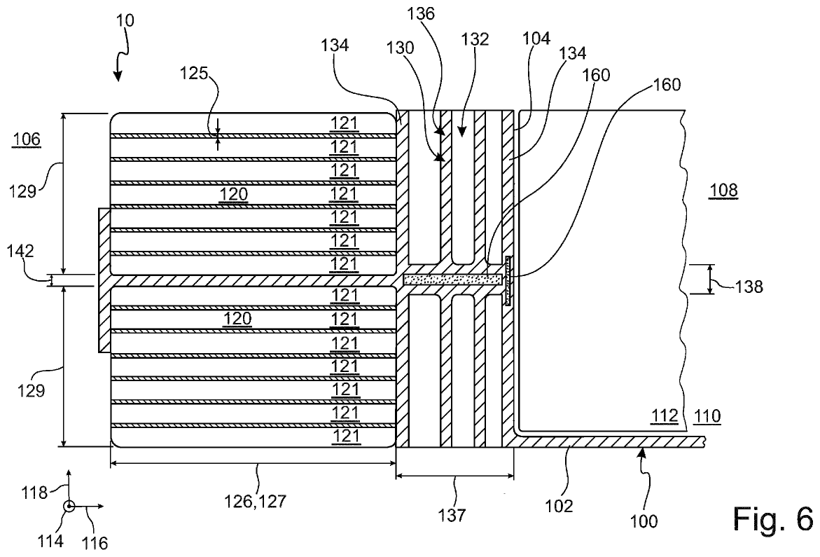

FIG. 6: schematically shows a detail of a fifth embodiment of a battery shell system in a sectional view.

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

The battery shell system 10 in FIG. 1 substantially consists of a battery shell 100 and two deformation elements 120, which are arranged on a first side of the battery shell. The battery shell 100 can preferably be closed with a battery cover 170.

It goes without saying that all embodiments of battery shells 100 can also be understood mirror-symmetrically, so that one or more deformation elements can also be arranged on the other side of the battery shell 100.

The detail of an embodiment of a monolithically formed battery shell 100 in FIG. 1 has a battery shell 100 consisting of a base 102, at least one side wall 104 and an outer stiffening means 130, the battery shell 100 having an inner side 108, an outer side 106, a longitudinal direction 114, a transverse direction 116 and a vertical direction 118.

The outer stiffening means 130 has a U-profile and extends in the longitudinal direction 114 of the battery shell 100 and consists substantially of two cover layers 132, wherein one of the cover layers 13 coincides with the side wall 104 of the battery shell 100, a spacer element 132, which keeps the two cover layers 134 at a distance from one another even under load and the associated deformation, so that they make a significant contribution to at least one area moment of inertia of the battery shell 100.

The core 132 of the outer stiffening means has a cross-rib structure 136 which optimally stiffens the rigidity of the outer stiffening means while at the same time maintaining a low weight.

The battery shell 100 also has a receiving space 110 for receiving at least one battery module (not shown).

Furthermore, the monolithically formed battery shell 100 has a holding structure 140 with an I-profile and a wall thickness 142 for partially receiving two deformation elements 120 and is configured for connection to the deformation elements 120.

Each deformation element 120 formed from plastic has a honeycomb structure with honeycombs 121, wherein the honeycombs 121 have a wall thickness 125 and a honeycomb longitudinal extent 126.

The honeycomb longitudinal extent 126 of the honeycombs 121 is oriented in a designated position of the deformation element 120 such that the honeycomb longitudinal extent 126 substantially corresponds to the transverse direction 116 of the battery shell 100.

“Substantially” is understood here to mean differential angles less than or equal to 10°, preferably a differential angle less than or equal to 5° and particularly preferably a differential angle less than or equal to 2.5°.

Furthermore, the battery shell 100 has a ratio of a deformation element transverse extent 127 to a stiffening means transverse extent 137 which is expediently greater than or equal to 1, preferably greater than or equal to 1.3.

A deformation element has a deformation element vertical extent 129.

In the region of the outer stiffening means 130, the battery shell system 10 has continuous-fiber-reinforced layers 160 which increase the rigidity and the penetration resistance of the outer stiffening means 130.

The battery shell system in FIG. 2 has an outer stiffening means 130 which has an I-profile. Here the wall thickness 138 of the web (not denoted) of the outer stiffening means 130 is thicker than the wall thickness 142 of the holding structure.

The honeycomb structure 122 for a deformation element (not shown) in FIG. 3 has a plurality of interconnected honeycombs 121. The honeycombs have a longitudinal axis 123, a side length 124 and a wall thickness 125.

Compared to the embodiment in FIG. 1, the battery shell system 10 in FIG. 4 has deformation elements with a longer honeycomb longitudinal extent 126. In addition, a battery module 112 is also arranged in the receiving space 110 of the battery shell in FIG. 4.

The battery shell system 10 in FIG. 5 is shown in a plan view, whereby, in particular, the cross-rib structure 136 of the upwardly open outer stiffening means 130 is clearly visible. Furthermore, the battery shell system 10 has an inner stiffening means 150 which extends through the receiving space 110, the outer stiffening means 130 and the holding structure 140. The inner stiffening means 150 additionally extends between two adjacent battery modules 112. The inner stiffening means 150 is preferably formed monolithically with the battery shell.

The holding structure 140 has two connecting means 128, by means of which the deformation elements 120 can be connected to the holding structure 140 of the battery shell 100 and/or to the body shell of the designated motor vehicle (not shown). Furthermore, it should be borne in mind that by using the connecting means 128 the holding structure 140 of the battery shell 100 can be connected to the body shell of the designated motor vehicle (not shown).

In the region of the outer stiffening means 130, the battery shell system 10 in FIG. 6 has continuous-fiber-reinforced layers 160 which increase the rigidity and the penetration resistance of the outer stiffening means 130.

According to a variant (not shown) of the outer stiffening means 130 shown in a sectional view in FIGS. 1, 2 and 6, the outer stiffening means has exactly one continuous-fiber-reinforced layer 160, in particular within the top cover layer 134 oriented toward the inner side 108 of the battery shell 100, or within the top cover layer 134 oriented toward the outer side 106 of the battery shell 100, which increases the rigidity and the penetration resistance of the outer stiffening means 130.

### LIST OF REFERENCE SIGNS

10 Battery shell system
100 Battery shell
102 Base
104 Side wall
106 Outer side
108 Inner side
110 Receiving space
112 Battery module
114 Longitudinal direction
116 Transverse direction
118 Vertical direction
120 Deformation element
121 Honeycomb
122 Honeycomb structure
123 Longitudinal axis
124 Side length
125 Wall thickness
126 Honeycomb longitudinal extent
127 Deformation element transverse extent
128 Connecting means
129 Deformation element vertical extent
130 Outer stiffening means
132 Core
134 Cover layer
136 Cross-rib structure
137 Stiffening means transverse extent
138 Wall thickness
140 Holding structure
142 Wall thickness
150 Inner stiffening means
160 Continuous-fiber-reinforced reinforcement layer
170 Battery cover

1. A battery shell system comprising:
a battery shell, wherein the battery shell has a base and at least four side walls, wherein the battery shell has an inner side and an outer side, wherein the battery shell has a maximum longitudinal extent in a longitudinal direction, a maximum transverse extent in a transverse direction, and a maximum vertical extent in a vertical direction, and wherein the battery shell has a receiving space on the inner side for receiving at least one battery module; and
at least one deformation element which is connectable to the outer side of the battery shell and is formed separately from the battery shell, wherein the deformation element has a deformation element transverse extent which extends in the transverse direction of the battery shell, and the at least one deformation element is formed from a ductile plastic having an elongation at break greater than or equal to 0.3.

2. (canceled)

3. The battery shell system according to claim 1, wherein the deformation element is formed from a plastic that is a polymer blend.

4. The battery shell system according to claim 3, wherein the polymer blend has at least one of: polycarbonate, polybutylene terephthalate, polyphenylene ether, polystyrene, or a polyamide.

5. The battery shell system according to claim 1, wherein the deformation element is formed by an injection-molding method or a compression-molding method.

6. The battery shell system according to claim 1, wherein the deformation element has a honeycomb structure having a hexagonal cross-section, and having at least one honeycomb with a longitudinal axis, wherein the longitudinal axis of the at least one honeycomb corresponds substantially to the transverse direction of the battery shell in an installed state of the deformation element.

7. The battery shell system according to claim 6, wherein the at least one honeycomb has a side length in a range of 8 mm to 16 mm.

8. The battery shell system according to claim 6, wherein the at least one honeycomb has a wall thickness greater than or equal to 1.2 mm.

9. The battery shell system according to claim 6, wherein the at least one honeycomb has a ratio of wall thickness to side length in a range of greater than or equal to 0.08 and less than or equal to 0.18.

10. The battery shell system according to claim 6, wherein the at least one honeycomb has a deformation element vertical extent greater than or equal to 50 mm, preferably greater than or equal to 60 mm, and particularly preferably greater than or equal to 70 mm.

11. The battery shell system according to claim 1, wherein the battery shell has an outer stiffening means formed monolithically with the battery shell, wherein the outer stiffening means is arranged between the receiving space of the battery shell and the at least one deformation element is connected to the battery shell, wherein the outer stiffening means has a stiffening means transverse extent in the transverse direction of the battery shell.

12. The battery shell system according to claim 11, wherein the outer stiffening means has a U-profile which is open in the vertical direction of the battery shell.

13. The battery shell system according to claim 11, wherein the outer stiffening means has a T-profile open in the vertical direction of the battery shell.

14. The battery shell according to claim 11, wherein the outer stiffening means has a structured core in a middle of two cover layers bounding the structured core, wherein the structured core has a cross-rib structure.

15. The battery shell system according to claim 11, wherein a ratio of the deformation element transverse extent to the stiffening means transverse extent is greater than or equal to 1.

16. The battery shell system according to claim 1, wherein the battery shell has a holding structure for guiding and/or connecting the deformation element, wherein the holding structure is monolithically formed with the battery shell, and arranged on the outer side of the battery shell, and arranged outside the stiffening means as viewed from the receiving space.

17. The battery shell system according to claim 16, wherein the holding structure has a connecting means which is configured for connection to the at least one deformation element.

18. The battery shell system according to claim 16, wherein a wall thickness of the holding structure is less than or equal to 4 mm.

19. The battery shell system according to claim 1, wherein the battery shell has at least one inner stiffening means on the outer side of the battery shell also extends over the deformation element transverse extent, which extends on the outer side of the battery shell also over the deformation element transverse extent and the stiffening means transverse extent.

20. The battery shell system according to claim 1, wherein the battery shell is formed from plastic

21. The battery shell system according to claim 1, wherein the at least one outer stiffening means and/or the holding structure have a fiber-reinforced reinforcement layer.

22. The battery shell system according to claim 1, wherein the battery shell system is implemented in a traction battery, for a motor vehicle.

23. The battery shell system according to claim 1, wherein the battery shell system is implemented in a motor vehicle.
